(19) United States
(12) Patent Application Publication
(10) Pub. No.: US 2005/0071249 A1
(43) Pub. Date: Mar. 31, 2005

(54) E-commerce repricing system

(76) Inventors: Geoff Nix, Emeryville, CA (US); Martin Manley, Oakland, CA (US); Kristina Webster, Oakland, CA (US); Jesse Baldwin, Cloverdale, CA (US); Paul Pritchard, Piedmont, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/949,156

(22) Filed: Sep. 24, 2004

Related U.S. Application Data
(60) Provisional application No. 60/506,340, filed on Sep. 25, 2003.

(51) Int. Cl. G06F 17/60

(52) U.S. Cl. 705/26

(57) ABSTRACT

A repricing system calculates new prices for goods based on pricing data received from a plurality of sources and updates the prices of the good. In an embodiment, a pricing engine determines a market price based on the pricing data and calculates a new price for the good based on the market price and seller repricing instructions. In another embodiment, the pricing data comprises prices of used versions of the good and/or the distribution of prices of the good. In another embodiment, repricing is triggered by the elapsing of a predetermined interval of time. Using an embodiment of the invention, a seller can automatically recalibrate her prices on a regular basis.

### CROSS REFERENCE TO RELATED APPLICATIONS

This application claims the benefit of U.S. provisional application No. 60/506,340, entitled “Delivery of Pricing Information to Sellers” and filed Sep. 25, 2003, which is hereby incorporated by reference in its entirety.

### BACKGROUND

1. Field of the Invention

This invention relates generally to pricing management systems, and in particular to systems and methods for managing the dynamic pricing and re-pricing of new and used goods for sale on the Internet.

2. Background of the Invention

The growth of the Internet has been accompanied by a proliferation of websites selling new and used goods. While online sales as a share of overall sales of new goods continues to grow, the Internet has arguably more dramatically transformed the market for resold goods, which has been reinvented through sites such e-Bay and Amazon.com. Consumers can now comparison-shop multiple retailers selling the same new or used item, for ultimate purchase on or off-line.

The wealth of sales outlets and information readily available to consumers has created new price pressure for sellers. Sellers must constantly re-evaluate their prices using available pricing information from a variety of sources. Even assuming that new prices can be devised quickly, implementing them can consume considerable resources. In a bricks and mortar environment, individual items must be re-tagged and re-shelved. Even online, because market fluctuations can impact different items differently, repricing and updating must often be done manually, item by item. Blunter repricing measures such as blanket discounts are available, but trade off product profitability for administrative ease. In markets where new and used products compete head-to-head, such as in the market for books, pricing management can be particularly challenging.

For these reasons, there is a need to improve the capability of sellers to rapidly make and implement pricing and re-pricing decisions.

### SUMMARY OF THE INVENTION

In accordance with the present invention, a computer program product can reprice a good for sale in an online transaction. The product comprises a computer readable medium and computer program instructions for receiving pricing data for the good from a plurality of sources, calculating a market price for the good responsive to the pricing data, and determining a new price for the good responsive to the market price and a repricing instruction from a seller.

In another embodiment, the invention comprises, for example, the elements of a memory, a pricing engine, and a pricing management module. The memory stores current prices of a plurality of goods, and the pricing engine calculates new prices for the goods based on repricing instructions and pricing data for each of the goods. The pricing management module is for updating in the memory the current prices with the new prices of the goods.

In another embodiment, a good is repriced for sale in an online transaction. Pricing data for the good is received from a plurality of sources and a market price for the good is calculated based on the pricing data. Responsive to a repricing trigger, a new price of the good is automatically determined responsive to the market price and a predetermined instruction from a seller. Accordingly, the new price of the good is updated.

### BRIEF DESCRIPTION OF THE DRAWINGS

FIG. 1 is a high-level block diagram of a repricing system in accordance with an embodiment of the invention.

FIG. 2 is a high-level block diagram of a computer system for hosting one or more components of the system of FIG. 1 in accordance with an embodiment of the invention.

FIG. 3 is a flowchart illustrating the high-level steps of determining a new price for a good and updating the price with a new price.

FIG. 4 is a flowchart illustrating steps for calculating an exemplary market price for a used good based on pricing data.

FIG. 5 is a high-level block diagram of a pricing management system in accordance with an embodiment of the invention.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

While the present invention will be described in connection with preferred embodiments thereof, it will be understood that the description is not intended to limit the invention to those embodiments. On the contrary, it does not cover all alternatives, modifications, and equivalents as may be included within the spirit and scope of the invention as defined by the claims.

Repricing System

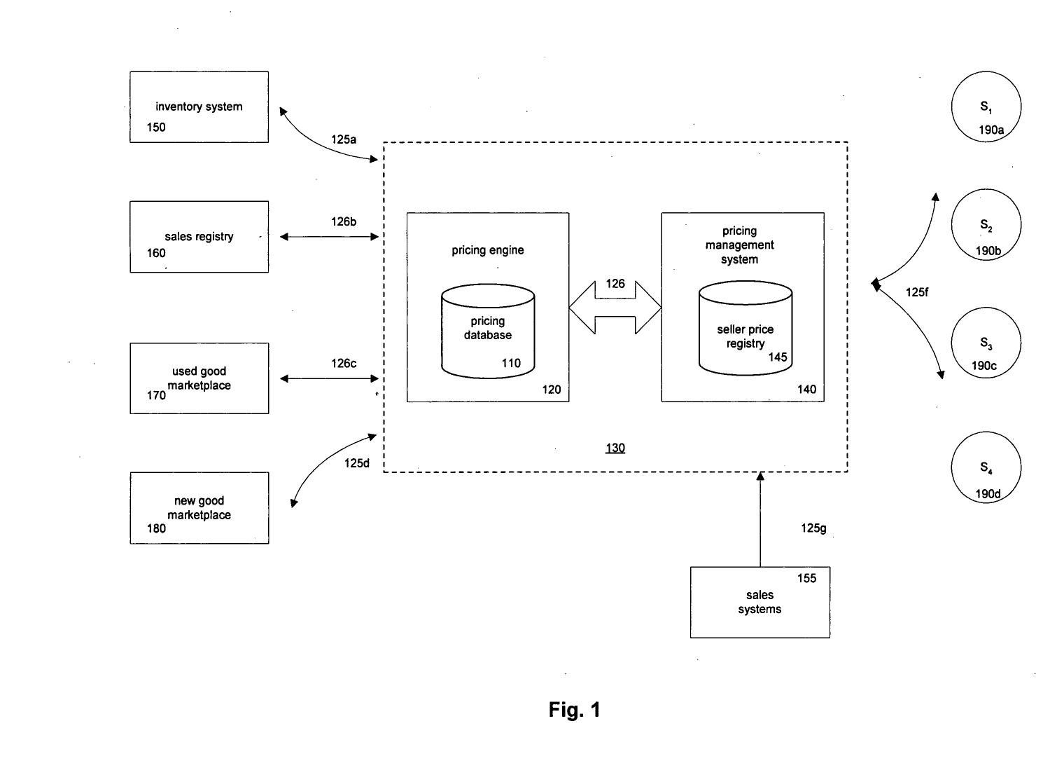

FIG. 1 is a high-level block diagram of a repricing system 130 in accordance with an embodiment of the invention. The repricing system 130 includes a pricing engine 120 and a pricing management system 140. The pricing engine 120 receives pricing data from a variety of sources 150-190 communicatively coupled to the repricing system 130 and stores the data in a pricing database 110. The pricing engine 120 uses this data to calculate price metrics of goods and provides these metrics to sellers 190 of the goods through the pricing management system 140. Sellers 190, through the pricing management system 140, can provide instructions to reprice the goods, whose current prices are stored in the seller price registry 145. The new prices are calculated by the pricing engine 110 and updated in the seller price registry 145. The new prices can be provided back to the sellers 190 for use in an online or other transaction. Or, the registry 145 may be communicatively coupled to a sales system 155 to which the new prices are provided, for pricing and selling the repriced goods. By automating aspects of the repricing process, the system 130 makes it possible to efficiently and quickly respond to competitive and market pressures.

The repricing system 130 is configured to calculate new prices for goods. As used throughout this description, the term “good” includes any new or used item, ware, object, merchandise, consumer or durable good, or other sellable product or service. A good may comprise an individual unique good, such as a painting, or a commodity such as a new book, CD, or DVD. Individual goods can represent members of broader categories or classes of products. For instance, in the book context, Melville's Moby Dick has been published in several different editions, languages, and binding types. Each of the unique published versions of the book (for instance, the 1967 Norton soft cover edition) comprises a distinct good. Thus the title “Moby Dick” is associated with a number of individual “goods” or unique versions of the book. At the same time, there may be multiple copies of the same good, in new or used form, available for sale.

Goods may be identified in any number of ways, with varying levels of specificity. For instance, a good can be identified by a unique identifier assigned according to a specific convention such as the Universal Product Code (UPC) or International Standard Book Numbering (ISBN) system. Or the good can be identified by one or more descriptors or attributes of the good, such as its size, year, source, language, make, or combination of other qualities, or in the case of books, by its author, title, or binding. More than one good may be associated with a given attribute or descriptor combination. For instance, within a repository of books, various book versions may qualify as an English-language softcover edition of Austen's Pride and Prejudice, whereas only one softcover version will be associated with a particular ISBN. The differences in specificity provided by an attribute-based identifier (e.g. binding, author, and title) as opposed to a unique identifier (i.e. ISBN) warrant using different approaches in the calculation of averages and other values as is described in more detail below.

Pricing Database

The pricing database 110 stores pricing data received from sources 150-190 and pricing metrics generated by the pricing engine 120 based on the pricing data. The database 110 may include one or more flat, relational, or other types of databases and can comprise a relational database management system (RDBMS) such as offered by Oracle, Sybase, Informix, or Microsoft SQL.

The database 110 stores records containing pricing data regarding one or more goods. Each record comprises an identifier of the good and a price associated with a new or used version of the good. As described above, the identifier may vary depending on the information available for each item. For example, in the book context, publishers assign unique ISBNs to an edition of a book before it is published. A single ISBN can further be associated with specific binding types (hardback, softback, electronic book). Thus, records of book data within the database 110 can uniquely identify the good or book version by an ISBN/binding combination. However, if the ISBN of a copy of a book is not available, because it is incomplete, missing, or because the book was published before the ISBN system was developed, the book can be identified in other ways. In one embodiment, the title and author of the book, together comprising the “work” identifier, and the binding of the book are used to identify the good in pricing data records of the database 110 that do not include an ISBN. As shown in Table 1, under this identification scheme, data provided by a single data source 190 could be stored in four records, each with a different ISBN or work/binding combinations. Naturally, other formats and profiling schemes depending on the good and available data may be used. In addition, a single database 110 can include records for different types of goods and/or for new and used versions of the same good, and may contain dedicated database portions for different sets of records.

TABLE 1

| | | | Used | Copies | |
|---|---|---|---|---|---|
| ISBN | Work | Binding | Price | Available | Seller |
| 12312312011 | Melville's | Hard | 13.50 | 2 | ResellerA |
| | Moby Dick | | | | |
| 38922200018 | Melville's | Soft | 6.50 | 9 | ResellerA |
| | Moby Dick | | | | |
| XXXXXXXX | Melville's | Hard | 10.00 | 12 | ResellerA |
| | Moby Dick | | | | |
| XXXXXXXX | Melville's | Soft | 2.50 | 15 | ResellerA |
| | Moby Dick | | | | |

The data records within the pricing database 110 may have information about a good other than its price. Optional database fields could include: the source of the data and the date of the data, the quantity of the good available at the stored price, and a field for identifying exceptional goods whose prices are not comparable to market prices. For instance, again in the book context, a database record could identify whether the good is a rare, collectible, or antiquarian book, or if it is a signed and/or first edition copy. The record may feature a flag for identifying that the record is not appropriate for inclusion in calculations based on the pricing data.

The database 110 stores pricing metrics calculated by the pricing engine 120 based on the pricing data provided by the various sources 150-190. These metrics are described in greater detail below with reference to the Pricing Engine.

Data Sources

Pricing data is provided by various sources 150-190 to the repricing system 130 and stored in the pricing database 110. Requests for the data, and responses containing the data from the various sources 150-190, may be transported over various network connections 125 as shown. As discussed throughout this application, the term “network connection” includes any connection or combination of connections supported by a digital, analog, satellite, wireless, firewire (IEEE 1394), 802.11, RF, local and/or wide area network, Ethernet, instant message, TCP/IP, HTTP, email, web server, or other communications device, router, or protocol.

Pricing data may be provided from an inventory system 150. The inventory system 150 tracks the prices of products for a retail or wholesale establishment. In an embodiment, the inventory system 150 catalogs the advertised or available prices of goods at a warehouse or other wholesale outlet, and identifies the goods according to a unique identifier such as an UPC. Or, the inventory system 150 may assign each item in inventory a unique SystemID that correlates to inventory system specific parameters, such as shelf location, or order status. The same good (e.g. 1976 hardback edition of Moby Dick) may be assigned several SystemIDs. Before the inventory data is stored to the pricing database 110, data for like goods may be mapped to a common identifier unique to the good or otherwise adapted for storage in the database 110.

Pricing data may also be sourced from a sales registry 160. While the inventory system 150 provides current price information, the sales registry 160 provides data on the prices at which goods have been sold in the past. Reflective of historical trends and fluctuations in the market, past prices may prove to be more or less predictive of future market prices depending on a variety of factors. For instance, if a significant event takes place, such as the success of a movie version of a book, the winning of a prize by a book, or the success of another book by the same author, past prices may not be as useful for setting a new price for the book.

Information may also be provided from one or more third party marketplaces 170, 180. These marketplaces 170,180 may comprise bricks and mortar or online marketplaces and may aggregate sellers, as in the case of eBay or Amazon.com, that offer different prices for new and used versions of the same item or the same item sold through different sales channels. The data from marketplaces 170, 180 may be obtained in a variety of ways. In an embodiment, the marketplace 170, 180 regularly or upon request supplies pricing data to the repricing system 130. This information could be provided through network connection 125 according to any number of ways including a web services data feed that automatically appends or updates fields in the pricing database 110 on a regular basis. The repricing system 130 may also actively obtain pricing information using spiders, crawlers or other methods or technologies for gathering historical, competitive and other pricing data. Or the information could be purchased from a data aggregator or another source. The prices of new goods may be presented in terms of an established price and a discount from the price. In the case of books, for instance, the marketplace for new goods 180 could comprise a publisher of books that provides the publisher's list price or other established price for the book and information about discounts available to various retailers or buyers of the book.

Individual sellers 190 may also provide current prices or past sales data regarding their goods to the repricing system 130. In an embodiment, individual sellers 190 access an interface of the pricing management system 140 using a computer with Internet access and upload pricing data in a spreadsheet or use an online tool to enter pricing values. The information is then sent over a network connection 125f using any of a variety of data transmission methods.

Data from the different sources 150-190 may be provided on different cycles, for instance, according to business or sales drivers, or may be obtained upon request or at regular interval. For instance individual sellers 190 may only send their data when they access the pricing management system 140 to carry out other tasks such as repricing. Information from a third party marketplace 170 or 180, however, may be provided in response to a request sent by the repricing system 130 for instance by sending an FTP request to download the data to the pricing database 110. Data based on standard types of prices such as suggested retail, list, or publisher's prices, may be updated less frequently depending on the good. A request to any of the sources 150-190 may identify the type of data sought, for instance limiting the data to only goods that are in the recent inventory of the sellers 190.

Pricing Engine

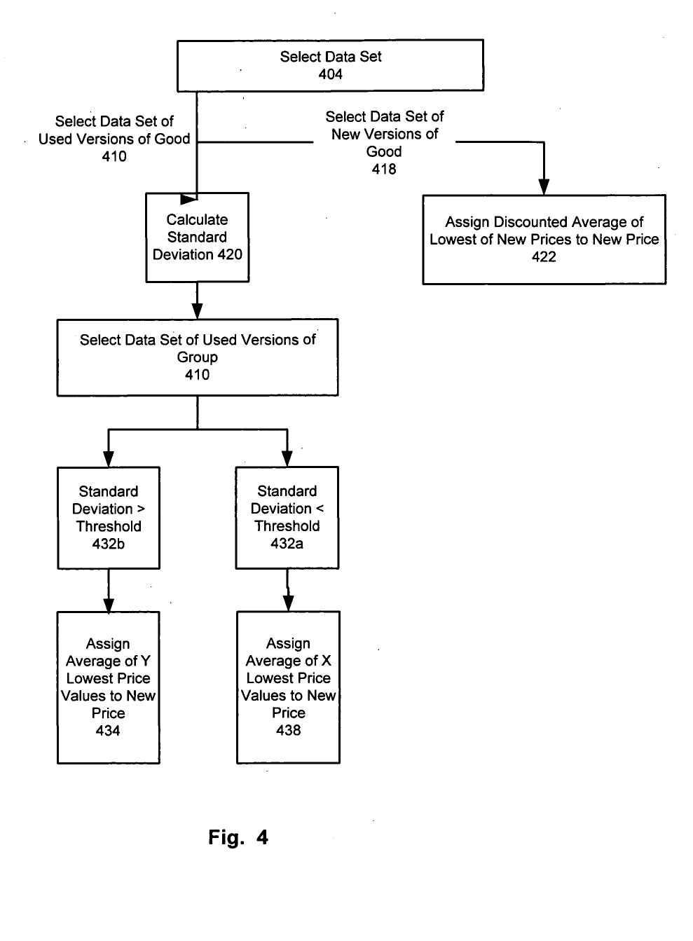

The pricing engine 120 accesses data in the database 110 and uses it to calculate various pricing metrics. These metrics may include a market price and benchmark prices for a used or new version of the good. The market price reflects a competitive price of a good calculated based on application of an algorithm to a variety of sources of market data. Explained in greater detail with reference to FIG. 4, in one embodiment, the market price is calculated based on comparable prices of new versions of a good, including a published price and sold prices, and the prices, number, and distribution of used versions of the good for sale in various marketplaces. The benchmark prices, on the other hand, reflect averages and means of various subsets of pricing data. Together, these market price and benchmark price metrics may be provided to a seller 190 through the pricing management system 140 to aid in repricing decisions. The seller 190 may in turn provide repricing instructions based on the pricing metrics to the repricing system 130 through the pricing management system 140. The engine 120 calculates new prices for the seller's goods based on one or more metrics in conjunction with the seller's instructions. The new prices may be saved to the seller price registry and/or output to the sellers 190 through the pricing management system 140.

The engine 120 may calculate a wide variety of benchmark prices to help the seller 190 decide how to reprice a certain new or used good. The benchmarks could include an average price of the lowest or highest prices available in a market, a minimum price in a market, the inventory of used or new goods in one or more markets sold over a certain period, or other indicator. The market could comprise a generally dominant market, such as the Amazon marketplace for books, or a more specialized market. How a benchmark for a good is calculated may depend on how the good is identified. Again, returning to the exemplary book context, in an embodiment, there may be two different books, one identified by a unique ISBN/binding combination and the other defined by a less unique work/binding combination. An average used price for the book identified by the ISBN/binding may be calculated by ranking all of the price records for used versions of the good and, then calculating the average based on the lowest 3 prices of the good. For the good identified by its work/binding combination, a similar exercise could be performed. However, because the work/binding combination is less precise and could include records for books published in different years and by different publishers, the average is attained by taking the mean of more data points, five values, for instance. Each of these calculations would exclude records in the pricing database 110 for exceptional inventory items for instance marked “signed” or “1^{st} edition”.

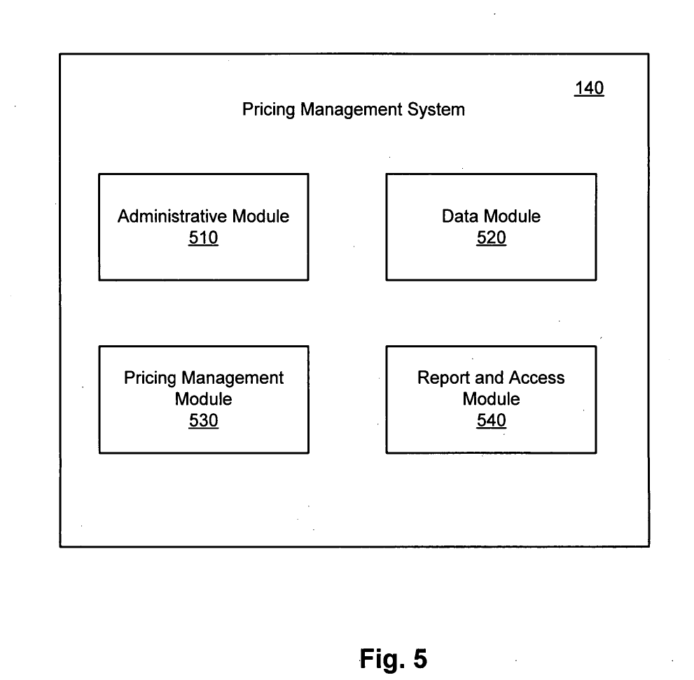

The engine 120 can also calculate price metrics other than the benchmark and market prices of a good. It may also generate reports, described below with reference to FIG. 5, or views of the current and benchmark or market prices in comparison with current prices stored in the seller price registry 145 or sales performance data that may be provided to the pricing management system 140 by the seller 190. For instance, the engine 120 may determine how many goods are currently priced above or below a certain threshold of difference with the market good or benchmark price.

Price Registry/Sales System

As shown in FIG. 1, current prices are maintained in the seller price registry 145. Prices in the price registry 145 may be updated manually by sellers 190 or automatically according to seller instructions. The pricing information may be provided to one or more sales systems 155 communicatively coupled to the repricing system 130 over a network connection 125g. An individual sales system 155 may be run by a seller 190, seller sales partners, or other entity that sell the good on behalf of the seller 190. A sales system 155 supports transactions for the sale of seller goods and may provide services such as order processing, billing, credit card processing, identity verification, and shipping and handling. In an embodiment, a single entity provides both repricing services through the repricing system 130 and sales services through a sales system 155 to sellers 190.

Configuration

In the system shown in FIG. 1, the pricing engine 120, pricing management system 140, sales systems 155, and data sources 150-190 comprise separate and distinct elements. However, it is not necessary for every embodiment of the invention to include all of the elements depicted. Furthermore, it is not necessary for the elements to be housed as shown; the elements can be hosted by other entities or in sub-modules of the elements may stand-alone or together. In some implementations of the system, the various elements may also appear in different configurations. For instance, the pricing database 110 is shown in the system 130 as separate from the seller price registry 145, in other embodiments, however, the two are integrated. In another embodiment, the inventory system 150 and sales registry 160 are maintained together or the used and new goods marketplaces 170,180 are subcomponents of the same marketplace and provide their data together. Likewise, as other elements and sub-elements are described throughout the invention, it should be understood that various embodiments of the invention may exclude elements and sub-elements described.

Computer System

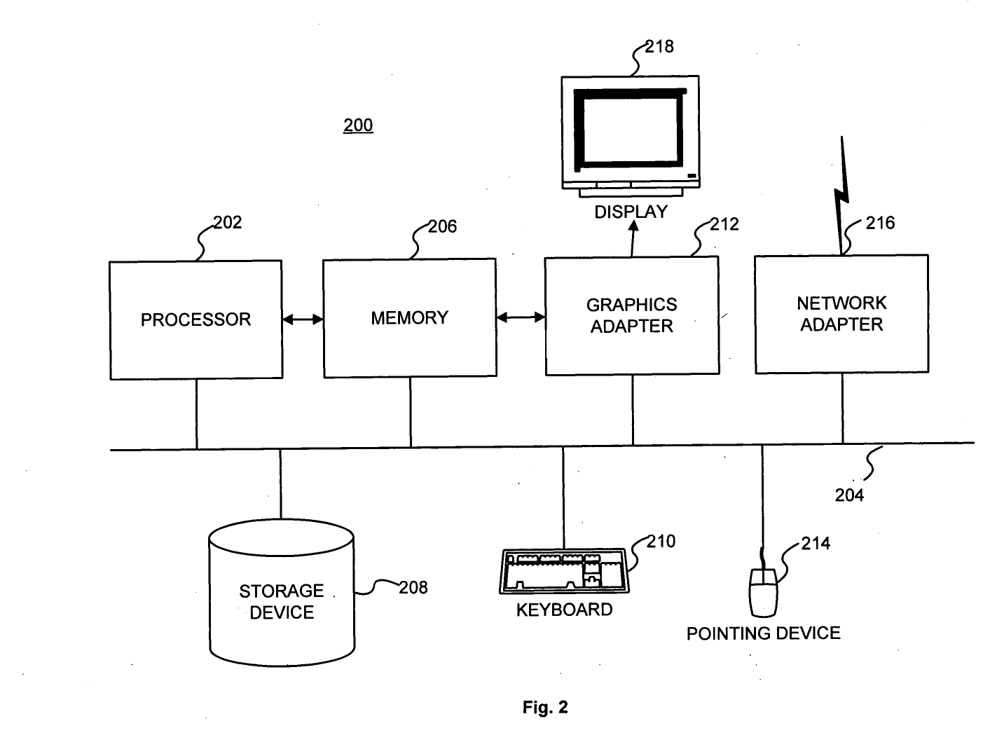

FIG. 2 is a high-level block diagram of a computer system 200 for hosting one or more components of the system of FIG. 1 in accordance with an embodiment of the invention. Other elements and sub-elements described below may also be hosted on such a computer 200. Illustrated are at least one processor 202 coupled to a bus 204. Also coupled to the bus 204 are a memory 206, a storage device 208, a keyboard 210, a graphics adapter 212, a pointing device 214, and a network adapter 216. A display 218 is coupled to the graphics adapter 212. The computer system 200 may take the form of a server, laptop, workstation, handheld device, or other general-purpose or specialized computing device.

The processor 202 may be any general-purpose processor such as an INTEL x86, SUN MICROSYSTEMS SPARC, HP NonStop, or POWERPC compatible-CPU. The storage device 208 is, in one embodiment, a hard disk drive but can also be any other device capable of storing data, such as a writeable compact disk (CD) or DVD, or a solid-state memory device. The memory 206 may be, for example, firmware, read-only memory (ROM), non-volatile random access memory (NVRAM), and/or RAM, and holds instructions and data used by the processor 202. The pointing device 214 may be a mouse, track ball, or other type of pointing device, and is used in combination with the keyboard 210 to input data into the computer system 200. The graphics adapter 212 displays images and other information on the display 218. The network adapter 216 couples the computer system 200 to the network.

As is known in the art, the computer system 200 is adapted to execute computer program modules for providing functionality described herein. As used herein, the term “module” can refer to computer program logic for providing the specified functionality. A module can be implemented in hardware, firmware, and/or software. Preferably, a module is stored on the storage device 208, loaded into the memory 206, and executed by the processor 202.

The types of hardware and software within the computer system 200 may vary depending upon the implementation of the repricing system 130. For example, a repricing system 130 operating in a high-volume environment may have multiple processors and hard drive subsystems in order to provide a high processing throughput, as well as be coupled to multiple sales systems 155. Likewise, certain embodiments may omit components, such as the display 218, keyboard 210, and/or network adapter 216 depending upon the specific capabilities of the system. In addition, the computer system 200 may support additional conventional functionality not described in detail herein, such as displaying images in a variety of formats, allowing users to securely log into the system, and supporting administrative capabilities.

Pricing Management System

FIG. 5 is a high-level block diagram of a pricing management system 140 in accordance with an embodiment of the invention. As shown, the pricing management system 140 includes several modules 510-540 that support repricing and management of the online sales of goods. Sellers 190 can use the modules 510-540 to provide pricing data to the repricing system 130, receive pricing metrics generated by the pricing engine 120, search for pricing data contained in the pricing database 110, supply repricing instructions to the repricing system 130, download new prices from the repricing system 130, and effect new prices in the seller price registry 145.

Administrative Module

The seller 190 can provide her repricing instructions and repricing management preferences through the administrative module 510. The administrative module 510 may include interfaces for allowing the seller 190 to express her preferences and/or repricing instructions. Such preferences/instructions may comprise for instance, the types of data to include or exclude in pricing calculations, what pricing benchmarks the seller 190 would like to view, what market or benchmark price at which to reprice the seller's prices, a schedule of repricing triggers, the form in which the seller 190 would like to receive reports and other outputs from the repricing system and the types of goods to exclude from repricing (i.e. one of a kind or rare goods). The administrative module 510 may also include an interface through which inventory management and other activity preferences can be specified. For instance, in an embodiment, the administrative module 510 allows a seller 190 to express a default sales channel or store location, packaging preferences, and default attributes about the good.

Data Module

The data module 520 allows sellers 190 to upload and download pricing data to the pricing system. The module 520 may include, for instance, a link to an FTP site to which a seller 190 can supply a worksheet or other file containing its sales activity data. In addition, on a regular basis or when prices have been changed by the pricing engine 120, a seller 190 can use the administrative module 510 to download a file including the current prices at which the seller's goods are available that includes the new prices. One or both of the transfer of pricing data to and from the seller 190 may also be provided by automated get and set commands provided over an abstraction layer that connects the repricing system to one or more systems of the seller 190.

Report and Access Module

The seller 190 may use the report and access module 540 to request and obtain pricing and other reports, as well as access information stored in the repricing system 130 about goods sold by itself or others. Any of a variety of views or reports can be generated and provided by the reports module. In one embodiment, the report module 540 can be used to create a report that summarizes how a seller's 190 listings generally compare against a pricing metric. In another, the report includes a sample of price variances in the sellers listings based on any of variety of baseline index values. In another embodiment, the report module 540 automatically generates a report showing the number of items that are due to be repriced and the prices at which they will be repriced. The report is sent to the seller 190 prior to the act of repricing, allowing the seller 190 to review the proposed new prices and take any necessary steps to change the new prices. The seller 190 or other user can specify the content and format of the report and/or other report preferences through the report module 540.

The report and access module 540 also provides an interface to data stored in the repricing system 130, for instance in the pricing database 110. The module 540 allows sellers to search for goods sold by itself or other parties. Goods can be identified according to any of a variety of descriptors, attributes, or identifying values. The module 540 may allow a user to specify what data to include or exclude in the search and what data should be omitted from the search results. The search results can be further customized to be sorted according to various parameters such as last edit data price, or pricing variance with a benchmark or market price, or other pricing metric such as price range or type of seller. The report and access module 540 may comprise a pricing dashboard that integrates pricing data with inventory data to show how sales of inventory before and after a repricing event, or track other data designated by the seller.

Pricing Management Module

The seller 190 can use the pricing management module 530 to provide repricing instructions to the repricing system 510 and effect repricing. The seller can review benchmarks, suggested prices, market prices, current prices, and other such values and override, select or designate these values to become the new price for a good. Once the seller 190 has approved the prices, uploaded its desired prices, or otherwise designated the new prices it wants to use, it can send a command through the pricing management module 530 to effect repricing. This results in the new prices being appended to the pricing registry 145, to be provided on to various sales systems 155 for sale of the repriced good.

Determining and Updating a New Price for a Good

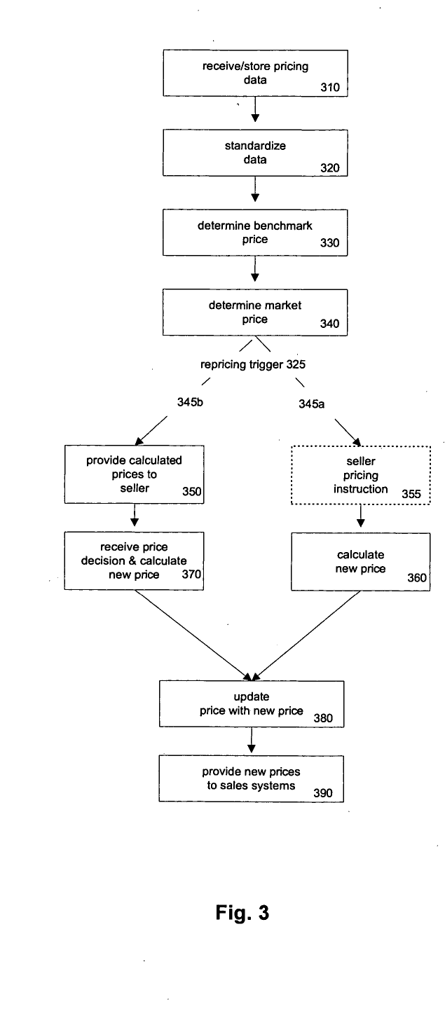

FIG. 3 is a flowchart illustrating the high-level steps of determining a new price for a good and updating the price with the new price using the repricing system 130 of FIG. 1. The repricing system receives 310 pricing data from various sources 150-190 and stores 310 it in the pricing database 110. One or more sellers 190 may provide pricing data about goods offered for sale by the seller through a data module 520 of the pricing management system 140. The data is standardized 320 so that it can be uniformly associated with an identified good. This step may require converting the received pricing data into a uniform database format, making any necessary currency or pricing adjustments so that a uniform unit of good is used, and/or mapping the data from a set of descriptors used by the source 150-190 to a uniform identifier. The data is then used to determine 330 one or more benchmark prices according to one of the methods disclosed above or another method. A market price is then determined 340 by the pricing engine 120, using a method such as the one described with reference to FIG. 4.

The process of repricing, which culminates in updating 380 the price of the good, can be initiated by a repricing trigger 325. The seller 190 may expressly request repricing, by clicking or otherwise selecting a repricing option on an interface of the repricing system 130. Or repricing could be automatically triggered 325 on a regular schedule set by the seller 190 such as once a quarter. Repricing then may proceed according to at least two routes 345.

Under the first route 345a, the process of repricing is carried out automatically without any intervention from the seller 190. The seller has previously provided a pricing instruction to the pricing engine 120, through an administrative module of the pricing management system 140 for instance. The pricing instruction 355 could communicate that the seller's price should be adjusted to the market price plus a margin of 5%. The pricing instruction, stored in the seller price registry 145 or other memory, may be accessed by the pricing engine 120 and applied to the market price to calculate 360 a new price for the good. The price of the good is automatically updated 380 in the seller price registry 145, and may be provided 390 to various sales systems 155 for offering the good at the new price. The seller 190 may also download the new prices through the data module 520 of the pricing management system 140. In a variation of this route 345a, the new prices of the good are provided to the seller in a report generated by a report and access module 540 before the new prices take effect, to give the seller 190 an opportunity to change her mind if desired.

Under the second route 345b, the seller 190 engages in a more interactive process to determine a new price for the good. One or more of the calculated price metrics is provided 350 to the seller 190 in any of a variety of ways, including by sending the seller 190 an email or by supplying the values through an interface. The seller 190 may request that various data be presented in a report from the report and access module 540 or use the module 540 to browse price information stored in the pricing database 110. In an embodiment, a “default” price, calculated according to instructions previously provided by the seller 190 through the administrative module 510 is also provided to the seller 190. The seller 190 accesses these prices through a pricing management module 530 and uses them to make a pricing decision such as “update price to default”; “retain price”; or “revise price to benchmark.” The pricing decision is received by the engine 370, which uses it to calculate 370 a new price. The new prices are updated 380 in the seller registry 145 and provided 390 to the appropriate sales systems 155 or the seller 190.

Determining a Market Price

A market price can be determined according to any of a variety of methods. FIG. 4 is a flowchart illustrating exemplary steps to calculate a market price for a used version of a good based on pricing data that could be carried out by the pricing engine 120 of the repricing system 130 of FIG. 1. To calculate a price for a used good, a data set may be 410 chosen from among several data sets for the calculation. For example, the various data sets could comprise the real-time or most recently uploaded prices for used versions of the good offered in one or more markets, historical prices at which used versions of the good were sold, or prices of new versions of the good. A data set is selected 404 from the various options according to the quantity of data available and a hierarchy. In an embodiment, the data set must contain a certain number of data points or otherwise reflect a large enough sample size in order to be used. In addition, data for used versions of the good may be selected over data for new prices of the good since the object is to get a market price for a used version of a good. In addition, among different sources of data for used versions of the good, data that comes from a larger market could be favored over data provided from a smaller market.

In an embodiment, if no satisfactory data sets containing prices of used versions of the good is found, a data set containing prices of new versions of the good is selected 418. The market price is assigned 422 a value that is equivalent to the discounted value of the lowest known price of a new version of the good offered in the marketplace.

In another embodiment, a data set reflecting offered and sold prices of used versions of the good is selected 410. A standard deviation, to measure how tightly clustered the pricing values are, is calculated 420. The result is compared 430 against a predetermined threshold. If the standard deviation is below a certain threshold 432a, the market price is assigned 438 a value equal to the average of a given number, x, of values of the lowest prices of the good in the data set. If the standard deviation is above the threshold 432b this means that the values are relatively less clustered than if the standard deviation were below the threshold. Because the data is relatively more spread out, the market price is assigned 434 a value equal to the average of a larger number, y, of lowest prices than would be used if the values were more clustered. This approach is based on the observation that a low standard deviation means that more sellers are using the same or similar prices and that there is a greater agreement in the marketplace about the value of the good. This increases confidence that the values presented are appropriate. If the standard deviation is relatively larger, on the other hand, this means that there is a greater risk of outlier prices, the impact of which can be minimized by using a larger sample size.

Once the market price of the good is determined, additional steps can be performed to determine a new price for the good. As illustrated in FIG. 3, a pricing instruction or pricing decision may be provided to the pricing engine 120 by the seller 190, for instance, and followed to reach the new price. In an embodiment, the instruction comprises a pricing rule that the greater of the market price and a predetermined minimum price be assigned as the new price. In another embodiment, a good can be repriced based on a factor or multiplier that reflects the condition of the good. For example, a book in excellent condition could be priced to 10% above market price whereas one in poor condition may be worth only 90% of the market price.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A computer program product for repricing a good for sale in an online transaction, the product comprising:
a computer readable medium; and
computer program instructions encoded on the medium for:
receiving pricing data for the good from a plurality of sources;
responsive to the pricing data, calculating a market price for the good; and
responsive to the market price and a repricing instruction from a seller, determining a new price for the good

2. The computer program product of claim 1, wherein the repricing instruction comprises a predetermined pricing rule received from the seller.

3. The computer program product of claim 1 further comprising computer program instructions for:
responsive to a repricing trigger, automatically determining the new price for the good and updating the new price of the good in the memory.

4. The computer program product of claim 3 wherein the repricing trigger comprises the elapsing of a predesignated interval of time.

5. The computer program product of claim 1, wherein the pricing data comprises a distribution of prices of the good.

6. The computer program product of claim 1, wherein the pricing data is received from at least one of: the seller, an inventory system, a sales registry, a marketplace for used versions of the good, and a marketplace for new versions of the good.

7. The computer program product of claim 1 wherein the pricing data comprises a plurality of prices for the good and further comprising instructions for:
calculating a standard deviation between the plurality of prices for the good; and
responsive to the pricing data and a comparison between the standard deviation and a predetermined threshold, calculating the market price for the good.

8. The computer program product of claim 1 further comprising instructions for:
responsive to the pricing data, calculating a benchmark price comprising one of an average price in a marketplace and a minimum price in a marketplace;
providing the benchmark price and the market price to the seller through a user interface; and
receiving the repricing instruction from the seller through the user interface after providing the benchmark price and the market price to the seller.

9. The computer program product of claim 1 for facilitating the online sale of the good, further comprising instructions for:
offering the good at the new price; and
receiving an order for the good at the new price.

10. The computer program product of claim 1 wherein the good is identified by one of: a unique identifier of the good and the combination of an identifying name of the good, the origin of the good, and an attribute of the good.

11. A method for repricing a good to be sold in an online transaction, the method comprising:
receiving pricing data for the good from a plurality of sources;
responsive to the pricing data, calculating a market price for the good; and
responsive to a repricing trigger, automatically determining a new price of the good responsive to the market price and a predetermined instruction from a seller, and updating the new price of the good.

12. The method of claim 11 wherein the pricing data comprises sales data for the good provided by the seller.

13. The method of claim 11 wherein the pricing data comprises a plurality of prices for the good, further comprising:
calculating a standard deviation between the plurality of prices for the good; and
responsive to the pricing data and a comparison between the standard deviation and a predetermined threshold, automatically determining the new price for the good.

14. The method of claim 11 further comprising:
responsive to the pricing data, calculating a benchmark price comprising one of an average price in a marketplace and a minimum price in a marketplace;
providing the benchmark price and the market price to the seller through a user interface; and
receiving the predetermined instruction from the seller through the user interface.

15. The method of claim 11 further comprising:
receiving report preferences from the seller;
generating a pricing report responsive to the report preferences; and
providing the pricing report to the seller.

16. A system for repricing a plurality of goods for sales in an online transaction, the system comprising:
a memory for storing current prices of the goods;
a pricing engine for calculating new prices for the goods for each of a plurality of sellers responsive to repricing instructions provided by each of the sellers and pricing data for each of the plurality of goods, each of the pricing data received from a plurality of sources; and
a pricing management module for updating in the memory the current prices with the new prices of the goods.

17. The system of claim 16 further comprising an administrative module for receiving from each of the plurality of sellers pricing data for each of the plurality of goods based on sales activity of the seller.

18. The system of claim 16 wherein, responsive to a repricing trigger,
the pricing engine is configured to automatically calculate new prices for the goods and supply the new prices to the price management module for updating the current prices with the new prices.

19. The system of claim 16 further comprising an administrative module for receiving repricing instructions from the plurality of sellers.

20. The system of claim 16 further comprising a data module for providing seller sales data to the repricing system.

21. The system of claim 16 further comprising:
a report module for receiving report preferences from an individual seller, generating a pricing report responsive to the report preferences, and providing the pricing report to the individual seller

22. A computer program product for repricing a good for sale in an online transaction, the product comprising:
a computer readable medium; and
computer program instructions encoded on the medium for:
calculating a standard deviation based on a set of prices for the good;
comparing the standard deviation to a predetermined threshold;
determining a market price responsive to relationship between the standard deviation and the threshold;
calculating a new price for the good responsive to the market price and a pricing instruction provided by a seller.
